(19) United States
(12) Patent Application Publication
(10) Pub. No.: US 2006/0230016 A1
(43) Pub. Date: Oct. 12, 2006

(54) Systems and methods for statistics over complex objects

(75) Inventors: Conor Cunningham, Redmond, WA (US); Jianjun Chen, Sammamish, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/091,983

(22) Filed: Mar. 29, 2005

(51) Int. Cl. G06F 17/30

(52) U.S. Cl. 707/2

(57) ABSTRACT

The subject invention relates to systems and methods that automatically create, update, and use statistics over complex objects within a database query processor. A system is provided that facilitates employment of statistics in connection with database optimization. The system includes a component that receives information relating to database performance and an optimization component that automatically identifies, from the information, a minimal set of statistics to employ in a query. A loader dynamically loads and employs the set of statistics during a query optimization process. The optimization component can employ the statistics over computed columns, whereby the columns can be computed from persisted and non-persisted data.

### TECHNICAL FIELD

The subject invention relates generally to computer systems, and more particularly, relates to systems and methods that enable advanced query processing over complex objects in a database system.

### BACKGROUND OF THE INVENTION

Modern commercial database query processors include query optimizers to find efficient execution strategies for submitted queries. Optimizers consider different execution strategies that return equivalent results to find a least-cost plan selection, for instance. These systems usually include optimizer costing function(s) and are generally based on statistical information derived from user data. For example, a sample of rows may be used to generate a distribution of frequent values in the data to help estimate the cardinality of the results of a query (or portions of the query) as well as the cost of each plan. As a result, accurate statistical information is essential to finding the least-cost plan and executing user queries efficiently.

Traditionally, databases did not contain statistical information unless a user manually created statistics over such data. Without statistics, the optimizer would assign a guess or estimate to the portions of a query tree lacking statistics. This can lead to sub-optimal query plan performance that is sometimes orders of magnitude worse than when running with statistics. One database server implementation included a feature that automatically-generated statistics for the user. This feature has recently started to appear in other database products as well. Automatic statistics generation can significantly improve overall query performance through the selection of better plans, and this functionality is generally available without any explicit user action.

More recently, databases have started adding support for complex, semi-structured, and hierarchical data in addition to “flat” tables, which has complicated the problem of identifying and automatically generating statistics for use in query optimization. For example, a “computed column” is a scalar expression that can appear as a column in a table that is based on other column data. This can be useful to avoid expensive computations by pre-computing the computations in a one-time manner or to present a richer table schema to users querying the table. Also, this scheme requires additional logic to identify and manage statistics properly. Additionally, databases have been adding object-relational extensions to allow structured objects to be stored in a database engine. Typically, a single column in a table represents a complex object with structural hierarchy and/or inheritance. This category of extension also requires extensions beyond traditional auto-statistics infrastructures.

### SUMMARY OF THE INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

The subject invention relates to systems and methods that automatically create, update, and employ statistics over complex objects within a database query processor and loader in order to generate efficient query plans. In one aspect, a query processor is enhanced over traditional query systems by enabling various features that support operations over complex objects such as user-defined data types in a database system, for example. Such features include statistical processing that facilitate a minimal amount of statistics to be created and loaded for use in a query which includes loading statistics dynamically over query optimization processing, for example. Other statistical processing includes creating, loading, and maintaining statistics over computed database columns which can be persisted and/or non-persisted storage forms. Still yet other aspects of the subject invention include advanced processing features for scalar values and expressions during various query optimization procedures.

In another aspect of the subject invention, complex object processing components provide functionality to reference scalar portions of complex objects, reference nested portions of complex objects, and reference derived portions of the objects in order to create, load, maintain and utilize statistics over these respective object portions. This includes features that provide query functionality to efficiently normalize object references, efficiently refresh statistics in the respective objects, and to integrate statistics within a cost-based query optimization framework in order to determine optimal query plans over complex objects.

To the accomplishment of the foregoing and related ends, certain illustrative aspects of the invention are described herein in connection with the following description and the annexed drawings. These aspects are indicative of various ways in which the invention may be practiced, all of which are intended to be covered by the subject invention. Other advantages and novel features of the invention may become apparent from the following detailed description of the invention when considered in conjunction with the drawings.

### BRIEF DESCRIPTION OF THE DRAWINGS

FIG. 1 is a schematic block diagram illustrating an automated query processing system in accordance with an aspect of the subject invention.

FIG. 2 is a diagram illustrating example query base processing in accordance with an aspect of the subject invention.

FIG. 3 illustrates query tree traversal processing in accordance with an aspect of the subject invention.

FIG. 4 illustrates dynamic statistical loading in accordance with an aspect of the subject invention.

FIG. 5 illustrates complex object processing in accordance with an aspect of the subject invention.

FIG. 6 illustrates computed column processing in accordance with an aspect of the subject invention.

FIG. 7 illustrates hierarchical structural processing in accordance with an aspect of the subject invention.

FIG. 8 illustrates complex object support features in accordance with an aspect of the subject invention.

FIG. 9 is a schematic block diagram illustrating a suitable operating environment in accordance with an aspect of the subject invention.

FIG. 10 is a schematic block diagram of a sample-computing environment with which the subject invention can interact.

### DETAILED DESCRIPTION OF THE INVENTION

The subject invention relates to systems and methods that automatically create, update, and use statistics over complex objects within a database query processor. In one aspect, a system is provided that facilitates employment of statistics in connection with database optimization. The system includes a component that receives information relating to database performance and an optimization component that automatically identifies, from the information, a minimal set of statistics to employ in a query. A loader dynamically loads the set of statistics during a query optimization process. The optimization component can employ the statistics over computed columns, whereby the columns can be computed from persisted and non-persisted data.

The subject invention can be applied to various application areas. Within the field of (commercial) database systems, the ability for a query processor to automatically identify, create, use, and maintain statistics over a minimal set of columns for efficient and effective query compilation is of considerable value. As the structure of data within a database becomes more complex, the need for automatically generated statistics becomes even greater since the number of degrees of freedom in the optimizer generally increases.

In one example application, a database engine adapted in accordance with the subject invention can be provided as a component in a broader system. For example, a file system can be constructed that stores files or file metadata in a database to enable efficient searching. This can improve overall search times when attempting to locate an email message or a document stored in some unknown location on a hard drive, for example. As can be appreciated, other such applications are also possible. One property to the success of such a system is that the database system should not impose significant additional management overhead when compared to the system in which it is embedded. Using this example, traditional file systems do not require a database administrator. Therefore, functionality that mitigates the need for a database administrator can significantly increase the number of applications facilitated by the subject invention.

As used in this application, the terms “component,” “system,” “object,” “query,” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. Also, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal).

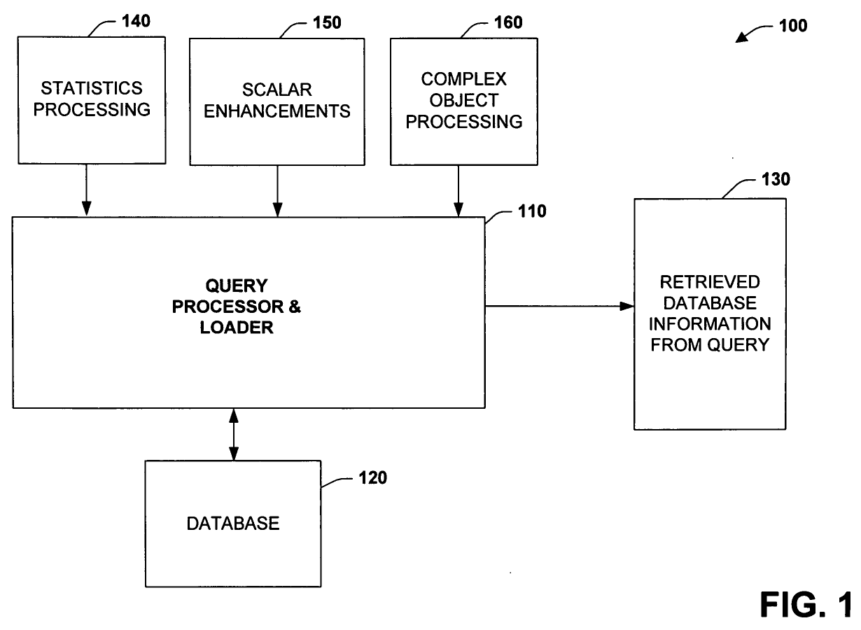

Referring initially to FIG. 1, an automated query processing system 100 is illustrated in accordance with an aspect of the subject invention. The system 100 includes a query processor and loader 110 that processes data from a database 120 and generates retrieved information 130 from the database in response to queries. Generally, the system 100 is employed to automatically create, update, and utilize statistics over complex objects within the query processor 110 for generating efficient query plans. The query processor 110 and database 120 can utilize a relational structure (e.g., Structured Query Language/Server) although substantially any database can be applied with the system 100. For instance, “object-relational” database systems can also be employed. Although some of the concepts described herein integrate object-relational concepts within a relational framework, it is to be appreciated that the subject invention can be employed with relational database systems, object-relational database systems, and/or databases within file systems, for example.

In one aspect, a statistics processing component 140, a scalar enhancement component 150, and a complex object processing component 160 is provided with the query processor 110 to facilitate query plan generation. The statistics processing component 140 identifies a minimal set of statistics to create, load, maintain, and use in a query. This includes functionality to load statistics dynamically during an optimization process instead of once at or near the start of query optimization. Also, the statistics processing component 140 allows the query processor to create, load, maintain, and use statistics over computed columns, which can include persisted and non-persisted columns, for example. The scalar enhancements 150 enable a query optimization search framework that matches scalar expressions to computed column definitions. This includes the case when a name of the computed column was referenced in a user query as well as the case when a definition expression (or an equivalent form) of the computed column is employed. The subject enhancements 150 also provide the ability to create, load, maintain, and use statistics over scalar expressions without pre-creating computed columns.

Various features are supported by the complex object processing component 160. For instance, one feature enables the query processor 110 to reference scalar portions of complex/hierarchical objects within a database system and to create, load, maintain, and use statistics over these portions of complex/hierarchical objects. This includes the ability to reference nested scalar portions of complex/hierarchical objects within a database system and create, load, maintain, and use statistics over these portions of the objects as well (e.g., Person.Name.FirstName is a nested scalar within Person and Person.Name). Another feature allows the query processor 110 to reference derived scalar portions of complex/hierarchical objects within a database system and create, load, maintain, and use statistics over these portions (e.g., Student.School is a scalar that applies to the nested class Student that derives from Person).

In another aspect of complex object processing 160, the query processor 110 references nested set-based portions of complex/hierarchical objects within a database system (e.g., Person.SetofAddresses is a set of addresses attached to a person). This includes the ability to efficiently normalize references to complex/hierarchical objects (including nesting and derived objects) for identifying scalars within a complex/hierarchical object. This feature can also be employed to match statistics when expressions are not precisely the same as when the statistics were collected as well as minimize the number of statistics that are created and maintained. Other aspects of complex object processing 160 allow efficiently refreshing statistics in a complex/hierarchical object based on hierarchical tracking of changes made to objects stored in a storage unit (e.g., a table). This can include the ability to efficiently determine portions of complex objects within a hierarchy that are stored within the same portion of the hierarchy for efficiently maintaining and refreshing statistics over the complex objects. Also, the ability to integrate efficient creation, loading, maintenance, and use of statistics within a cost-based query optimization framework is provided that can efficiently determine optimal query plans over complex objects—including objects that support inheritance.

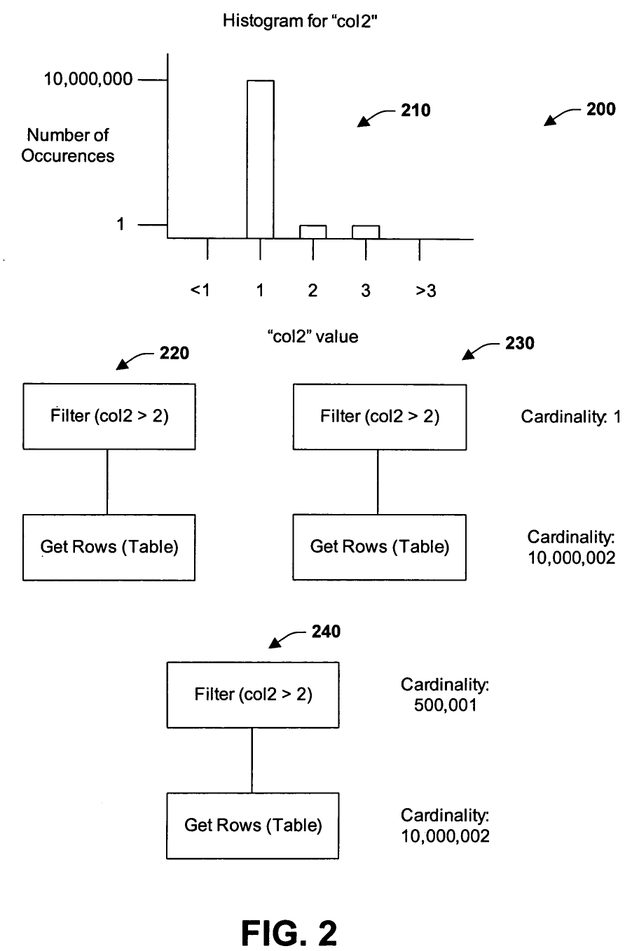

Referring now to FIG. 2, example query base processing aspects 200 are illustrated in accordance with an aspect of the subject invention. An example and basic query compilation pipeline in a modern database system may appear as follows:

SQL→PARSE→BIND→OPTIMIZE→FINAL PLAN

Sequential Query Language is parsed into an internal tree format that represents the operations to perform, where syntax is also validated during this phase. Then, the tree is validated (bound) to determine query references tables and columns that exist and to validate that semantics of the tree are logically in order. This is generally followed by an optimization phase that is performed to consider possible execution strategies for the query. In this context, the subject invention provides systems and methods to automatically create, load, maintain, and employ statistical information over data within a query processor.

Previous systems and methods provided an algorithm for identifying columns within a query that also needed statistics. This was based on a syntactic understanding of the query. Early in the query processor (e.g., in PARSE or BIND), columns were marked or tagged for statistical information based on the operator being generated. In the following example query, “col1” would be marked as interesting for statistics since it was part of a WHERE clause. SELECT * FROM Table WHERE col1+1>2. However, this type design has various limitations. First, the set of columns is determined syntactically. If this query included more complex logic, such as a computed column col2:=col1+1, the algorithm provides no efficient manner in which to determine that statistics on “col2” are more appropriate. Additionally, semantic information could potentially remove the need to load statistics for this query at all. For example, if a check constraint “col2<0” is defined, the query processor may determine that no rows will ever be returned by this query and skip the cardinality estimation steps that would use statistics in this example.

To illustrate the impact of this functionality on plan quality, assume the above noted example query is run against a table with many millions of rows and that an index exists on the computed column “col2.” Furthermore, assume that the query processor cardinality estimation algorithm uses a flat/constant distribution for all values in a data type's domain where statistical information such as histograms is not available. When statistics are available, they are used to estimate the cardinality. Thus, the col2 has a distribution as illustrated at 210 of FIG. 2. For this query, the distribution of values is skewed—almost all values are 1. An example internal query tree, used to generate a cardinality estimate, may appear as illustrated at 220.

For this query tree representation 220, “Get Rows” could retrieve rows from a base table or secondary index based on relative cost. Cardinality is useful to determine estimated query execution cost. For example, if a histogram is used to estimate cardinality on the computed column, the estimate would appear to be very small. In such a case, it is likely a better execution strategy to seek into a secondary index over col2, compare the rows retrieved, and retrieve base table rows for qualifying rows from the index as illustrated at 230.

If no histogram is used to make the estimation for the query, a different execution strategy may appear superior as illustrated at 240. If the cardinality estimation algorithm merely guessed that approximately half the rows qualify through the filter, then the expected number of rows returned in the query could be much higher. When presented with this number of rows, the query optimizer may select a plan that scans all rows in the base table. This could be significantly slower to execute. Accurate statistical information is therefore useful to selecting an efficient query plan and can have an impact on user-response time for queries. Consequently, matching computed columns (and thus their associated statistical information) can have an impact on plan quality and performance.

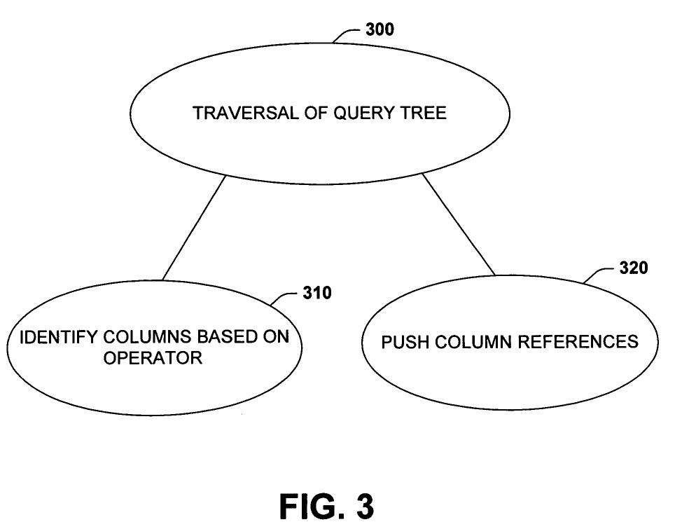

FIGS. 3-8 illustrate example query optimization processes for utilizing statistics in accordance with an aspect of the subject invention. While, for purposes of simplicity of explanation, the methodologies are shown and described as a series or number of acts, it is to be understood and appreciated that the subject invention is not limited by the order of acts, as some acts may, in accordance with the subject invention, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the subject invention.

Turning to FIG. 3, query tree traversal processing 300 is illustrated in accordance with an aspect of the subject invention. The subject invention is enhanced over previous methods in that it can more accurately determine a set of applicable statistics, allow additional statistics to be loaded at substantially any time during a run-time compilation process, and efficiently process additional “complex” constructs such as computed columns and complex structured types (such as user-defined types) including hierarchy and/or inheritance. At 300, a phase process performs at least a two-pass traversal of a given query tree during query optimization. One phase at 310 is a bottom-up tree traversal that identifies candidate columns based on the operator in which they reside. For example, the “Select” operation (which implements WHERE logic) can identify substantially all column references in the predicate as candidates for statistics since they have an impact on cardinality estimation. Respective internal query operators can have different logic, if desired. A second pass at 320 pushes column references towards their source tables and processes “column reference remapping” in a substantially seamless manner. The following is an example where column remapping can occur: SELECT Expr1000 FROM (SELECT col1 as Expr1000 FROM Table) WHERE Expr1000>100.

In this example, “col1” is aliased as Expr1000 in a query. In order for a statistics framework to load the statistics for estimation of this operator, the reference to Expr1000 should be identified as being derived from “col1” in Table 1 and mapped to a table on which the statistics are created. This process enables a number of additional optimizations to the process of identifying statistics candidates. For instance, performing this check later in the query pipeline allows refinements to the set of statistics to load. Computed columns can be identified and matched, allowing statistics over these objects to be used. Additionally, query simplifications can be utilized to prune the list of applicable statistics (and thus improving compilation performance). For example, if one performed a grouping operation on the primary key of a table, the grouping operation would no longer be needed since the rows are already unique. Thus, statistics are generally not needed to estimate the cardinality of the grouping operation as a result. Other extensions include reducing the set of grouping columns to mitigate duplicates and to remove grouping columns functionally determined by other columns in the grouping list. The following instruction represents another example aspect of the subject invention: SELECT PrimaryKeyCol FROM Table GROUP BY PrimaryKeyCol.

Another aspect to the query model described herein is that additional columns can be identified during the process of query optimization that were generally not identified in a syntax-only design. Update queries are typically represented by a single syntax-time operator and later expanded to include substantially all secondary indexes, indexed views, and constraints to enforce (including foreign key constraints which are represented as a join). If this expansion occurs after the identification of candidate columns for statistics, statistics cannot be loaded and the instruction join order for foreign key validation may be inefficient as a result.

Indexed view selection is another feature that benefits from the ability to identify columns on a semantically-bound tree. Indexed views are typically introduced into the query plan during query optimization. As these are materialized query results, statistics over them are usually of higher quality than the statistics employed by propagating base table statistics through a series of expected operations (as is performed without indexed views). The ability to load an indexed view enables more accurate statistics to be identified and utilized, potentially improving the quality and performance of the resulting query plan.

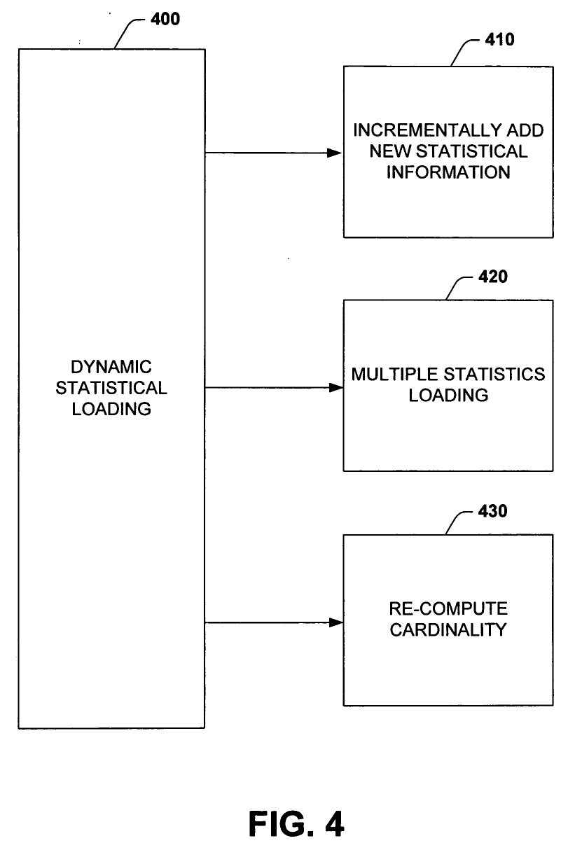

FIG. 4 illustrates a dynamic statistical loading process 400 in accordance with an aspect of the subject invention. In this aspect, capabilities are provided with respect to when statistics can be loaded and used in a query compilation framework or system. Previous frameworks often made significant assumptions about when statistics were loaded. Thus, it was not possible to load additional statistics identified as part of the optimization process as a result. The enhanced framework described herein includes improvements that facilitate performance of previous systems, repair previous methods that may not perform in all cases, and enable new classes of statistical information to be created, loaded, maintained, and used throughout query compilation and optimization.

In contrast to the improved processing model described herein, previous algorithms generally only had the ability to completely discard all statistical metadata and thus inefficiently reload it from a storage medium, for example. At 410 of FIG. 4, the enhanced model can incrementally add merely the new statistical information to an existing internal metadata representation, if desired, thus mitigating a full reload. At 420, multiple statistics loading aspects are provided. This includes changing the loading of statistics to be able to handle multiple attempts to load without actually re-loading statistics. Thus, operations such as computed column matching, indexed view loading, and update expansion can occur after the initial attempt to load statistics and estimate cardinality on the query. The subject invention provides the ability to reliably avoid duplicate work by centralizing information in the query tree and removing/repairing locations that cached metadata outside the scope of the cache. At 430, functionality is provided for recomputed cardinality if new stats are loaded/created during the search for a plan. By identifying substantially all positions where metadata information was used during the search, cardinality can be accurately recomputed when needed rather than as a general rule. This can be achieved by a logical separation of the logic performing the estimation from the code loading the statistics.

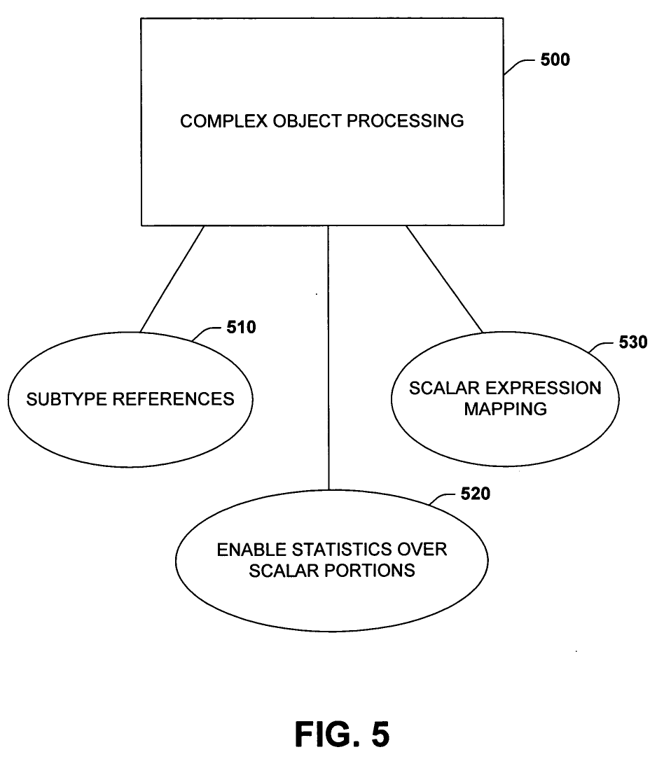

FIG. 5 illustrates complex object processing aspects 500 in accordance with an aspect of the subject invention. In this aspect, functionality is provided as an extension of an automatic statistical framework to process complex objects. This includes example outlines of a complex object processing component design and some of the benefits that are realized with the design. Complex objects generally go beyond a simple scalar value seen in modern commercial databases as supported data types for columns in tables. These can be built-in types or user-defined. Often, the most complex types are user-defined types (UDTs) and incorporate many fields into the definition of a single column. The complexity in these columns mimics the complexity observed in structure definitions in object-oriented programming languages. Specifically, objects can have complexity in their structure and/or have complexity in that they support object inheritance (the ability to specialize another object). Structural complexity can be manifested in supported many fields in an object or in terms of the depth of that structure (even supporting hierarchical or recursive object definitions). Inheritance complexity is associated with attempting to support multiple different objects within a single column of a table. Typically this is not widely supported in database engines since a performance benefit comes from the knowledge that rows are somewhat homogenous in nature both in terms of physical structure—i.e., columns are the same from row to row—and in terms of the query language (which operates over sets of homogenous objects).

Proceeding to 510 of FIG. 5, subtype reference functionality is provided. Object-relational databases typically support some form of inheritance within a column definition. As a result, extensions are needed to reference sub-types within an inheritance hierarchy. Specifically, it is useful to be able to identify the set of rows that contain instances of a particular sub-type as well as to identify portions of objects specific to that sub-type for reference in a query. In one specific example, SQL Server provides two constructs to extend its SQL syntax and relational algebra to support these concepts. For instance, “IS OF” is a scalar operation that determines if an object belongs to a specific sub-type, and “TREAT ( )” is a scalar function that allows binding to a sub-type's fields during a BIND phase of query optimization.

At 520 of FIG. 5, statistics are enabled over scalar database portions. Functionality is provided that enables a query processor to support statistical information over scalar portions of objects stored in the system (including sub-types identified by TREAT, for example). In (extended) SQL terms, statistics can be supported on scalar portions of complex objects—both structurally complex objects (e.g., Person.Name.FirstName) and inheritance complexity (e.g., TREAT (Person as Student).School). This can be integrated into the query optimizer's search framework to enable the re-use of a number of traditional relational concepts in the object-relational domain. It is noted that references to SQL examples such as TREAT ( ) are shown for exemplary purposes and that instructions can be represented as scalar path expressions containing references to portions of an object as well as references to functions such as TREAT.

At 530, scalar expression mapping functionality is provided. Matching arbitrary scalar expressions can be a difficult problem since there are often multiple ways to represent the similar objects. For example, col1+col2 is considered equivalent for col2+col1, but they are generally not represented in the same manner internally. The subject invention provides a solution for this difficulty to the subset of scalar expressions that represent object-relational extensions by mapping disparate representations into a singular or comparable form (e.g., scalar complex object path expressions that can include TREAT( )). As multiple equivalent scalar expression forms are mapped into a single comparable form, statistics can be created over that comparable form. As a result, fewer statistics are needed and thus, compilation and processing performance can be increased.

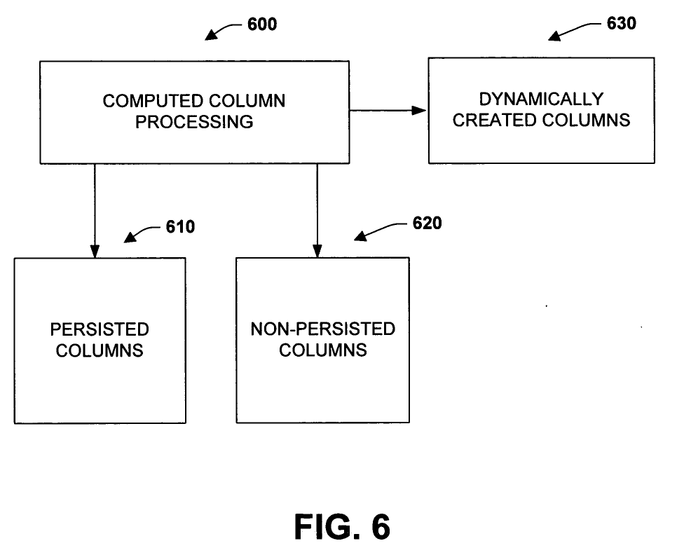

FIG. 6 illustrates computed column processing aspects 600 in accordance with an aspect of the subject invention. A computed column infrastructure provides a basis for how complex objects are supported in the statistical infrastructure. In general, computed columns can be persisted at 610 and/or non-persisted at 620. Non-persisted computed columns 620 are scalar expressions that are not stored in the storage engine but are computed from other values in a row. These previously could not support statistics. In some cases, computed columns are dynamically matched in the query processor using a two-pass process to collect scalar expressions in the query tree and then push them towards the leaves where computed columns are introduced by base table operators. This is conceptually similar to the process by which candidate statistics are loaded. When the scalar operations are pushed to the leaves of the query tree, each base table is examined to see if any persisted computed columns 610 match the expressions that have been successfully pushed to the leaves of the query tree. If they match, the scalar expression can be replaced by a reference to the persisted computed column in the storage engine. This existing mechanism is then extended to support statistics over complex objects.

At 630, dynamically created columns are provided. The subject invention extends statistical support to non-persisted computed columns 620 (which were not “matched” as described above). Thus, references to complex objects are identified (scalar complex object path expressions) when searching for persisted computed columns 610. If no computed column is found, a (e.g., fake, temporary) computed column is introduced into the optimization process to represent a normalized complex object scalar path expression (and replaced by the original expression at the end of optimization). Statistics are then associated with this column for the purposes of optimization. Various extensions to this optimization process are possible. One extension would be to create real computed columns as part of a query compilation process or to support arbitrary scalar expressions instead of merely references to complex objects.

Another extension allows the creation of indexes instead of/in addition to statistics over complex object's scalar path expressions without creating computed columns through this process. Thus, the use of dynamically-created columns 630 within the query processor has additional benefits. Generally, modern query processors reason about the domain of columns in the query to find logical contradictions in the query. For example, SELECT * FROM Table WHERE col1>10 returns no rows if col1 contains a CHECK constraint that limits all values to be less than 0. This logic works automatically if column references are used in query optimization instead of complex object scalar path references represented as scalar trees.

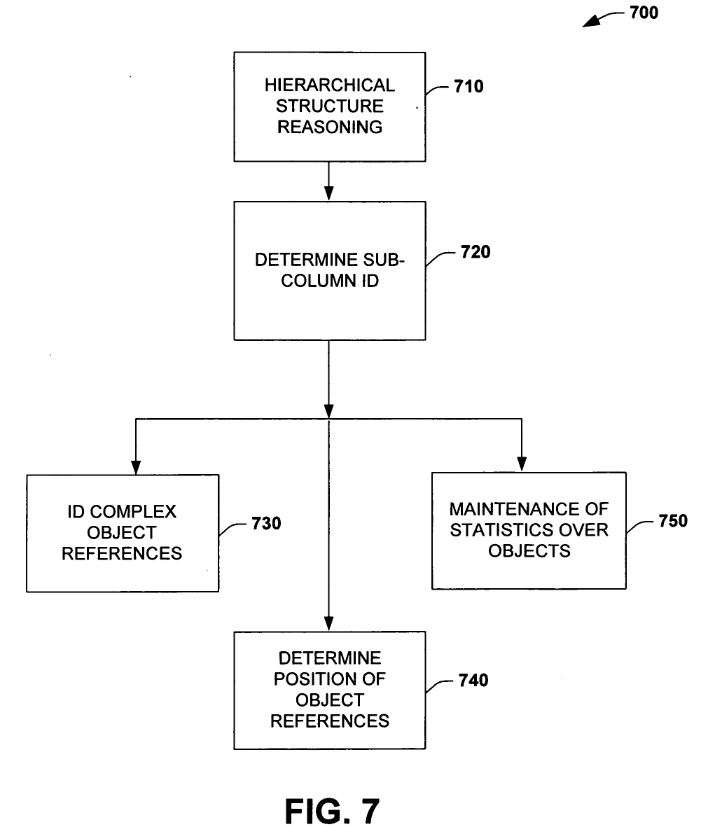

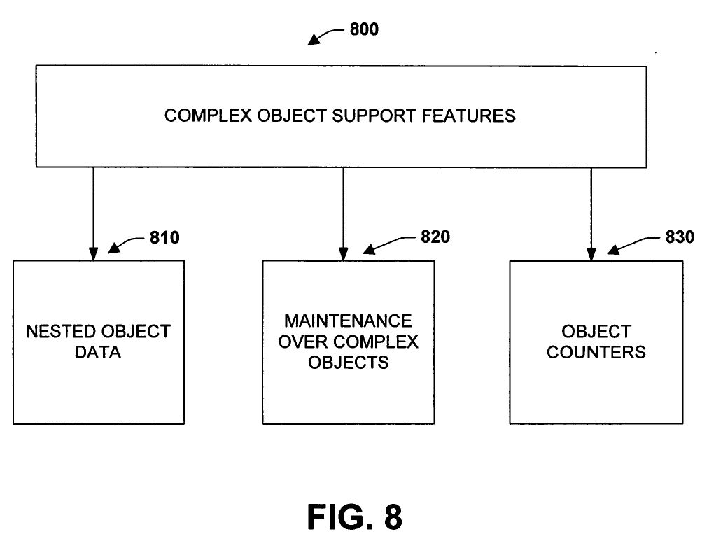

FIG. 7 illustrates hierarchical structural processing 700 in accordance with an aspect of the subject invention. Various extensions can be provided to reason about hierarchical structure in complex objects efficiently at 710. This includes providing a description of a “sub-column id” at 710 which encodes information about the structure of an object into a single scalar value which is described in more detail below. At 730, this type representation allows for efficient identification of equivalent complex object references by direct comparison of the sub-column id for each reference. Also, at 740 these type IDs promote efficient determination and execution of the relative position of two complex object references by determining a shared prefix of the sub-column id encoding. Efficient execution of queries over complex objects is enabled by allowing hierarchy navigation into complex objects to be shared for objects being referenced in a query. At 750, efficient maintenance of statistics over such objects is provided as is described in more detail below with respect to FIG. 8.

Before proceeding, sub-column ids noted above are described in more detail. In some previous methods, user-defined type (UDT) path expression access was represented internally using a scalar expression tree. Each level of this tree corresponds to a level of nesting both syntactically and in the respective storage format. Metadata provides interfaces to check each level of this hierarchy individually, but was not aware about the complete path.

The subject invention provides an encoding of this hierarchical UDT field reference that can be used through the query engine as a more efficient representation for representing a UDT field. This singular representation of the complete path is referred to as the sub-column id noted above. Typically, a sub-column id is a binary value defined as in the following example:

[typeid, ordinal]*

Typeid (4 bytes)—This represents a server's identifier for the typeid used at this level of the hierarchy.

Ordinal (4 bytes)—This represents the offset of the field within the current type (as defined in the compiled binary). Each level of the hierarchy is concatenated at the end of the previous level's hierarchy. Therefore, the sub-column id is a multiple of 8 bytes however, other implementations are possible. Sub-column ids generally have meaning within a particular type (or a column of that type). The following provides some specific examples to illustrate sub-column id encoding.

Example Encodings:

T.MyPerson.Name:

[typeid(Person), 0]

T.treat(MyPerson as Student).GPA:

[typeid(Student), 1]

T.MyPerson.HomeAddress.City

[typeid(Person), 2][typeid(Address), 1]

T.MyPerson.treat(HomeAddress as USAddress).ZIP

[typeid(Person), 2] [typeid(USAddress), 1]

FIG. 8 illustrates complex object support features 800 which support the aspects described above with respect to FIG. 7. Proceeding to 810, nested object data functionality is provided. In this aspect, the subject invention provides a process to support statistics over complex object data that is nested. Complex objects containing nested structure are represented as relational operators instead of computed columns since they can be multi-valued. As nested collections can have more rows than the original table, this collection more closely matches relational joins (and thus view statistics). Queries that “un-nest” collections (e.g., through a CROSS APPLY UNNEST ( ) language extension as seen in SQL Server) are exposed with a component that allows the object-relational problem to be mapped into standard relational algebra for matching more complex statistics on the relational expressions. This supports object-relational, database file-system, and hierarchical query extensions in statistics on views, for example.

At 820, a component for efficient maintenance of statistics over complex objects is provided. Some infrastructures measured changes to a column or a row in a table through counters that were incremented each time a row or column was changed. When a column's/row's counter reached a particular threshold, the statistics associated with that column were considered to be “stale” and were recomputed which led to inefficiency. If this mechanism were used for complex objects with many internal fields, all statistics over the complex object may become stale at once. Also, re-computation of the statistics can be expensive if the object contains many fields. If each field is treated as a column and given its own counter, calculation of the change for each object could be prohibitive since both field access and complete complex object replacement are possible (requiring that every counter be incremented).

At 830, the subject invention provides a compromise between a single counter and a counter per field. In one aspect, each branch of the object can be given a separate counter, even over inherited objects. Additionally, a top-level counter exists for each object in the type hierarchy. As most complex objects have many fields but do not have significant hierarchy, this allows most objects to be treated as columns to be modified with the overhead of a single counter modification. Replacing a complete object also only modifies a single counter. When statistics are checked for staleness, two comparisons are used instead of one. So, in substantially all cases, the number of counter modifications and comparisons is bounded to a constant thus promoting computation efficiency.

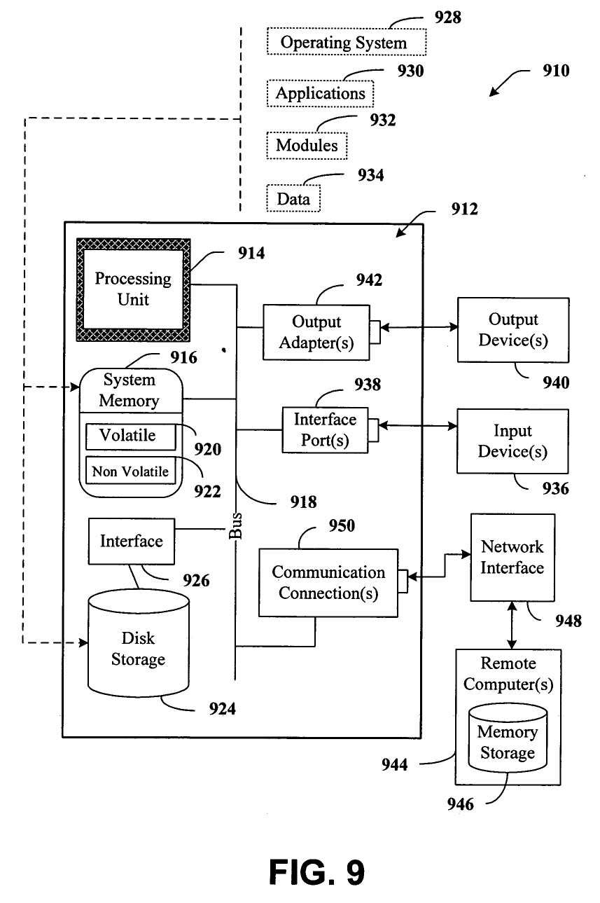

With reference to FIG. 9, an exemplary environment 910 for implementing various aspects of the invention includes a computer 912. The computer 912 includes a processing unit 914, a system memory 916, and a system bus 918. The system bus 918 couples system components including, but not limited to, the system memory 916 to the processing unit 914. The processing unit 914 can be any of various available processors. Dual microprocessors and other multiprocessor architectures also can be employed as the processing unit 914.

The system bus 918 can be any of several types of bus structure(s) including the memory bus or memory controller, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 916 includes volatile memory 920 and nonvolatile memory 922. The basic input/output system (BIOS), containing the basic routines to transfer information between elements within the computer 912, such as during start-up, is stored in nonvolatile memory 922. By way of illustration, and not limitation, nonvolatile memory 922 can include read only memory (ROM), programmable ROM (PROM), electrically programmable ROM (EPROM), electrically erasable ROM (EEPROM), or flash memory. Volatile memory 920 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 912 also includes removable/non-removable, volatile/non-volatile computer storage media. FIG. 9 illustrates, for example a disk storage 924. Disk storage 924 includes, but is not limited to, devices like a magnetic disk drive, floppy disk drive, tape drive, Jaz drive, Zip drive, LS-100 drive, flash memory card, or memory stick. In addition, disk storage 924 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 924 to the system bus 918, a removable or non-removable interface is typically used such as interface 926.

It is to be appreciated that FIG. 9 describes software that acts as an intermediary between users and the basic computer resources described in suitable operating environment 910. Such software includes an operating system 928. Operating system 928, which can be stored on disk storage 924, acts to control and allocate resources of the computer system 912. System applications 930 take advantage of the management of resources by operating system 928 through program modules 932 and program data 934 stored either in system memory 916 or on disk storage 924. It is to be appreciated that the subject invention can be implemented with various operating systems or combinations of operating systems.

A user enters commands or information into the computer 912 through input device(s) 936. Input devices 936 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 914 through the system bus 918 via interface port(s) 938. Interface port(s) 938 include, for example, a serial port, a parallel port, a game port, and a universal serial bus (USB). Output device(s) 940 use some of the same type of ports as input device(s) 936. Thus, for example, a USB port may be used to provide input to computer 912, and to output information from computer 912 to an output device 940. Output adapter 942 is provided to illustrate that there are some output devices 940 like monitors, speakers, and printers, among other output devices 940, that require special adapters. The output adapters 942 include, by way of illustration and not limitation, video and sound cards that provide a means of connection between the output device 940 and the system bus 918. It should be noted that other devices and/or systems of devices provide both input and output capabilities such as remote computer(s) 944.

Computer 912 can operate in a networked environment using logical connections to one or more remote computers, such as remote computer(s) 944. The remote computer(s) 944 can be a personal computer, a server, a router, a network PC, a workstation, a microprocessor based appliance, a peer device or other common network node and the like, and typically includes many or all of the elements described relative to computer 912. For purposes of brevity, only a memory storage device 946 is illustrated with remote computer(s) 944. Remote computer(s) 944 is logically connected to computer 912 through a network interface 948 and then physically connected via communication connection 950. Network interface 948 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 950 refers to the hardware/software employed to connect the network interface 948 to the bus 918. While communication connection 950 is shown for illustrative clarity inside computer 912, it can also be external to computer 912. The hardware/software necessary for connection to the network interface 948 includes, for exemplary purposes only, internal and external technologies such as, modems including regular telephone grade modems, cable modems and DSL modems, ISDN adapters, and Ethernet cards.

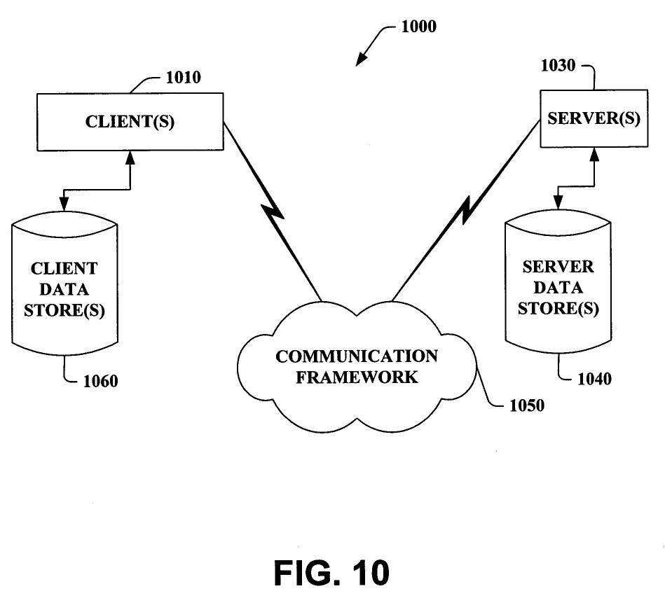

FIG. 10 is a schematic block diagram of a sample-computing environment 1000 with which the subject invention can interact. The system 1000 includes one or more client(s) 1010. The client(s) 1010 can be hardware and/or software (e.g., threads, processes, computing devices). The system 1000 also includes one or more server(s)

1030. The server(s) 1030 can also be hardware and/or software (e.g., threads, processes, computing devices). The servers 1030 can house threads to perform transformations by employing the subject invention, for example. One possible communication between a client 1010 and a server 1030 may be in the form of a data packet adapted to be transmitted between two or more computer processes. The system 1000 includes a communication framework 1050 that can be employed to facilitate communications between the client(s) 1010 and the server(s) 1030. The client(s) 1010 are operably connected to one or more client data store(s) 1060 that can be employed to store information local to the client(s) 1010. Similarly, the server(s) 1030 are operably connected to one or more server data store(s) 1040 that can be employed to store information local to the servers 1030.

What has been described above includes examples of the subject invention. It is, of course, not possible to describe every conceivable combination of components or methodologies for purposes of describing the subject invention, but one of ordinary skill in the art may recognize that many further combinations and permutations of the subject invention are possible. Accordingly, the subject invention is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that facilitates employment of statistics in connection with database optimization, comprising:
a first component that receives information relating to database performance;
an optimization component that automatically identifies, from the information, a minimal set of statistics to employ in a query;
a second component that automatically creates or updates the set of statistics upon detection the statistics are absent or stale with respect to a column or a computed column; and
a loader that dynamically loads and employs the set of statistics during an optimization process.

2. The system of claim 1, the optimization component employs the statistics over computed columns.

3. The system of claim 2, at least one of the columns are computed from persisted or non-persisted data.

4. The system of claim 2, further comprising a component that matches scalar expressions to the computed columns.

5. The system of claim 1, the second component is employed to select query plans via a cardinality estimation.

6. The system of claim 1, the optimization component employs the statistics over scalar expressions.

7. The system of claim 1, the optimization component references scalar portions of complex or hierarchical objects and employs the statistics over the objects.

8. The system of claim 1, the optimization component references nested scalar portions of complex or hierarchical objects and employs the statistics over the objects.

9. The system of claim 1, the optimization component references derived scalar portions of complex or hierarchical objects and employs the statistics over the objects.

10. The system of claim 1, further comprising a component that normalizes references to complex or hierarchical objects to facilitate identifying scalars within the object.

11. The system of claim 1, further comprising a statistics loading component that loads statistics in a complex or hierarchical object as a function of hierarchical tracking of changes made to the objects.

12. The system of claim 11, further comprising a utility component that employs the statistics within a cost-based framework to determine optimized query plans over complex objects.

13. The system of claim 11, the statistics loading component adds new statistical metadata information to an existing metadata representation of statistics.

14. The system of claim 12, the statistics loading component bifurcates loading of statistics.

15. The system of claim 1, the optimization component re-computes cardinality upon addition of new statistics.

16. A computer readable medium having computer readable instructions stored thereon for implementing the components of claim 1.

17. A method for database query planning, comprising:
mapping multiple database expression forms into a singular expression form for a database;
processing statistics in view of the singular expression form; and
generating a query plan for the database.

18. The method of claim 17, further comprising generating a sub-column id for the singular expression form.

19. The method of claim 17, further comprising processing nested objects with the singular expression form.

20. A system to facilitate database planning operations, comprising:
means for processing information relating to database statistics;
means for generating a plan that automatically identifies a subset of the statistics to employ in a database query; and
means for loading the subset of statistics during a database optimization process.
